(19) United States
(12) Patent Application Publication
(10) Pub. No.: US 2006/0015310 A1
(43) Pub. Date: Jan. 19, 2006

(54) METHOD FOR SIMULATION MODELING OF WELL FRACTURING

(75) Inventors: Anwar Husen, Cairo (EG); Raj Banerjee, Abington Oxon (GB)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(73) Assignee: SCHLUMBERGER TECHNOLOGY CORPORATION, Sugar Land, TX (US)

(21) Appl. No.: 10/710,526

(22) Filed: Jul. 19, 2004

(51) Int. Cl. G06G 7/48

(52) U.S. Cl. 703/10

(57) ABSTRACT

A model system for simulating the performance of a subterranean well, starts with a base model wherein input logging data, pressure transient data and PVT data is introduced into the base model. A numerical interpreter then calculates the predicted performance of the well. A match system compares actual performance data with calculated performance data based on the base model through reiterative loop for modifying the base model to provide a match between the actual performance data and the predicted performance data to optimize the base model. The method for generating the optimized performance data in accordance with the subject invention incorporates the steps of introducing known pressure transient data, well logging data and PVT data for the well into a base model and producing a performance prediction from the base model. These results are compared with actual performance data and the model is modified to generate a performance prediction that matches the actual performance for producing an optimized model. The method is particularly useful because it accounts for and adjusts the performance prediction based on non-Darcy factors effecting the fluid parameters in the well.

### BACKGROUND OF INVENTION

1. Field of the Invention

The subject invention is directed to a method for modeling well performance through simulation techniques taking into account non-Darcy fluid properties as well as load processed logs and pressure transient data.

2. Discussion of the Prior Art

Fracture stimulation is commonly used to increase the productivity of hydrocarbon fluids from subterranean formations. It is known, generally, to create models for simulating the operation of oil, gas or geothermal wells and more particularly, but not by way of limitation, for fracturing subterranean formations and determining characterizing information about the fractures, such as for use in monitoring or controlling the fracturing process or in performing subsequent fracturing jobs. This more generally includes determining characteristics of subterranean structures by obtaining and evaluating signals created in the well in response to one or more excitation events.

The prediction of faulting and fracturing is very important in oil and gas exploration and production. Seismic data is often used to find faults that bound or delineate hydrocarbon reservoirs. Knowledge of the distribution of the fractures in a geologic formation is of significant importance for optimizing the location and the spacing between the wells that are to be drilled through an oil formation. Furthermore, the geometry of the fracture network conditions influences the displacement of fluids on the reservoir scale as well as on the local scale, where it determines the elementary matrix blocks in which the oil is trapped. Knowledge of the distribution of the fractures is thus also useful at a later stage for the reservoir engineer who wants to extrapolate the production curves and to calibrate the models simulating reservoirs. The development of naturally fractured reservoirs thus requires better knowledge of the geometry of the fracture networks and of their contribution to the orientation of the flows.

Seismic data is commonly used for acquiring information about subsurface structures. Changes in the elastic properties of subsurface rocks appear as seismic reflections. Such changes in the properties of the rocks typically occur at boundaries between geologic formations, at fractures and at faults. The vertical resolution of the seismic method is approximately one-quarter wavelength of the seismic wave and, in typical situations, is of the order of 10 meters. The horizontal resolution is determined by the size of the Fresnel zone for the seismic wave at the depth of interest and may be tens or even hundreds of meters. By using sophisticated processing techniques, such as prestack migration taking advantage of data redundancy, the positions of the seismic reflectors may be more accurately determined up to the spacing of the geophones.

U.S. Pat. No. 5,953,680 issued to Divies et al describes a method for creating a two-dimensional (2-D) kinematic model of a geologic basin affected by faults. The basin is divided into a number of layers or banks whose geometric positions are known. The tectonic deformation of each modeled layer is determined separately by taking its thickness and length into account, with compaction being taken into account. The basic assumption is that the banks are competent units that undergo little deformation. The method does not include the material properties of the rocks as part of the input and hence is not particularly well suited for determining the effects of loading.

U.S. Pat. No. 5,838,634 issued to Jones et al obtains geologic models of the subsurface that are optimized to match as closely as feasible geologic constraints known or derived from observed geologic data. The models also conform to geophysically based constraints indicated by seismic survey data. It accounts for geophysical information by converting the geologic model to synthetic seismic traces, accounting for fluid saturation, and comparing these traces with observed seismic trace data. The process perturbs the rock properties in the geologic model until the geologic model is consistent with geologic and geophysical data and interpretations. However, the issue of how to obtain a reasonable fine-scale geologic model is not addressed.

Numerous fractured reservoir simulators have been developed using such a model, with specific improvements concerning the modeling of matrix-fracture flow exchanges governed by capillary, gravitational, viscous forces and compositional mechanisms, and consideration of matrix to matrix flow exchanges (dual permeability dual-porosity simulators). Various examples of prior art techniques are referred to in the following references: Thomas, L. K. et al: “Fractured Reservoir Simulation” SPE Journal (February 1983) 42-54. Quandalle, P. et al: “Typical Features of a New Multipurpose Reservoir Simulator”, SPE 16007 presented at the 9th SPE Symposium on Reservoir Simulation held in San Antonio, Tex., Feb. 1-4, 1987; and Coats, K. H.: “Implicit Compositional Simulation of Single-Porosity and Dual-Porosity Reservoirs,” SPE 18427 presented at the SPE Symposium on Reservoir Simulation held in Houston, Tex., eb. 6-8, 1989.

A problem met by reservoir engineers is to parameterize this basic model in order to obtain reliable flow predictions. In particular, the equivalent fracture permeabilities, as well as the size of matrix blocks, have to be known for each cell of the flow simulator. Whereas matrix permeability can be estimated from cores, the permeabilities of the fracture network contained in the cell, i.e. the equivalent fracture permeabilities, cannot be estimated in a simple way and require taking the geometry and properties of the actual fracture network into account.

Alternative prior art techniques in the field can be found, for example, in: Bourbiaux, B. et al: “Experimental Study of Cocurrent and Countercurrent Flows in Natural Porous Media,” SPE Reservoir Engineering (August 1990) 361-368.

Cuiec, L., et al.: “Oil Recovery by Imbibition in Low-Permeability Chalk,” SPE Formation Evaluation (September 1994) 200-208.

Techniques for integrating natural fracturing data into fractured reservoir models are also known in the art. Fracturing data are mainly of a geometric nature and include measurements of the density, length, azimuth and tilt of fracture planes observed either on outcrops, mine drifts, or cores or inferred from well logging. Different fracture sets can be differentiated and characterized by different statistical distributions of their fracture attributes. Once the fracturing patterns have been characterized, numerical networks of those fracture sets can be generated using a stochastic process respecting the statistical distributions of fracture parameters.

Typically, four different ways have been used for geologic modeling of and orientation of faults at one scale or in one deformational setting and to use simple statistical rules to extrapolate this information to other scales or deformational settings. An example of this is U.S. Pat. No. 5,659,135 to Cacas.

A second method that has been used for finite element modeling predicts the stress field from given input deformations. Once stress exceeds a given amount a fault or fracture is drawn in by hand and then the model simulation can continue. Alternatively, faulting patterns are put in by hand, and the formation is pressured up to estimate a stress distribution. The modeled rock is a network of distinct elastic elements, connected by elastic connection to its outer boundaries. The main obstacles to the application of such methods for geologic modeling are the computer time and the human interaction that is involved. The computer time roughly increases as the square of the number of nodes in the model and the models must be continuously interacted with by the user to put in new faults as they are believed to have occurred.

In a third method, large scale rules of geometry or faulting seen in the subsurface under certain deformation conditions are quantified and applied to forward modeling software. These forward models usually consist of a well-defined set of large scale shapes that are expected to be produced. An example of this is U.S. Pat. No. 5,661,698 issued to Cacas, which starts out with a group of major faults detected by means of an exploration of the zone, and additional minor faults that have not been detected during the exploration. The fractal characteristics of the major faults are determined and the additional minor faults are constrained to have the same fractal characteristics. The fractal characteristics used include the fractal dimension of the fault network and a density function defining a distribution of lengths of the faults. Such a method does not account for differences in the rock properties of different geologic formations and differences in their mode of faulting.

A fourth method that has been used is the so-called “distinct element model.” It uses small scale rules of stress and strain to move nodes in a model to predict faulting and fracturing. It is well suited for problems of geologic fracturing but suffers from the drawback of being computationally slow. In addition, the methods are not particularly user friendly in terms of user interface used for specification of the model and of the material properties.

Characterizing a well during operations relating to creating or operating the well can provide various information about what is downhole in the well or adjacent subterranean formations. This information may be used in performing the operation(s) on the respective well, or it may be useful in planning or conducting operations on other wells. Such information includes, for example, structural information (e.g., what objects are downhole, locations of what is downhole, and events that occur downhole) and parametric information (e.g., pressure, temperature and flow rate).

For example, knowledge of fracture dimensions permits wells to be drilled in optimal locations to take advantage of non-uniform drainage or injection patterns that hydraulic fractures may produce. In this way it may be possible to extract more of the resources in a field using a smaller number of wells than would be possible if fracture geometry were not known. Furthermore, information about the rate of hydraulic fracture growth can be used in improving the design and production of the fractures, thereby resulting in economic savings to the individuals and organizations who use hydraulic fractures in their operations.

Well characterization encompasses a wide range of technologies. One is well logging prior to installing casing. Sonar, with piezoelectric pressure signal generators operating in the audible frequency range, may be used. Sonar technology is expensive, time consuming, and relies on extensive software to interpret the reflected wave pattern.

After casing is cemented in place, well characterization typically includes techniques based on pressure/time transient analysis. In these, steady state is established, such as by making the well produce, capping it off, or by pumping fluid into the well; and then, for example, a well outlet valve at the surface is manually opened or closed at a normal speed. This starts a gradual change in well pressure, slow enough that it can be read from gauges in intervals of seconds to an hour or more. The reason for the pressure transient slowness is that the Darcy Law for fluid seepage governs it.

Pressure/time data and their derivatives are graphed on semi-log and log-log coordinates. The uniqueness of these slopes provides sufficient information to estimate well productivity, formation permeability, and reservoir geometry. These tests are performed without pulsatile flow present; therefore, the data have a high signal to noise ratio.

During well servicing such as in a fracturing process, pumps requiring thousands of horsepower are in operation. Pumping rate and treating pressure are operational constraints for a number of reasons. Injecting at too high a rate and thus pressure has the potential for fracturing out of the productive zone. The rate may also be limited because some fluids degrade under high shear rate. Another reason to limit the injection pressure may be tubular structure or available pump horsepower. However, high pumping rate is desirable to achieve high fluid efficiency, defined as the ratio of fracture volume created to the fluid volume pumped.

To collect well-defined pressure/time data during pumping, one must work with strong pressure signals. At high pumping rates, velocities may reach up to 40 feet/second in the flow passages. Transient fluid flow changes make a significant impact on the local friction pressure drop. Fracturing jobs often start with a “mini-frac” test. To do this, the pump speed is suddenly reduced (e.g., from 15 to 10 barrels/minute). The result is a sinusoidal pressure transient from which fluid efficiency, near well damage, and minimum in situ stress can be calculated.

Fracture size is another desirable characteristic to know. This has previously been obtained using conventional hydraulic impedance testing. In conventional hydraulic impedance testing, a relatively short duration pulse is produced at the surface and then the reflected signal is observed for one peak indicating the mouth of the fracture and another, smaller peak indicating the tip of the fracture. The time between the peaks is indicative of the fracture length and with an assumed volume and fracture profile, either the height or width can be determined. A shortcoming of this technique is that it is usually done in a static fluid condition due to large amounts of noise from pumps hiding the smaller reflected peak. The time frame for the pulse is typically longer than the travel time for the wave into and out of the fracture (especially at the start of the fracture stimulation process when the fracture is relatively short), which further smears, degrades or masks the signal of interest.

Other fracturing characteristics that are desirable to know and have been determinable include breakdown pressure when the fracture begins, screenout when proppant in the fracturing fluid reaches the tip of the fracture and plugs it off, and fracture closure pressure that exists after the fracture has partially closed when the fracturing pressure is released. These have been interpolated from various pressure versus time curves. For example, screenout has been deemed to exist at the beginning of a segment having a 1:1 ratio (slope of 1) in a curve representing the square root of pressure versus the square root of time; and fracture closure pressure has been interpolated from a pressure versus square root of time plot by drawing two tangential lines to the curve and at their point of intersection taking that pressure as the fracture closure pressure.

### SUMMARY OF INVENTION

As sophisticated as modeling has become over the years, the prior art techniques assume certain constants that do not exist in actual application. This makes the simulated well performance predictions, while acceptable, less than optimum predictions of performance through the fracturing techniques employed.

Darcy's Law is the fundamental constitutive relationship that defines the movement of fluids in subterranean formations. Darcy's Law states that the rate of fluid flow through a porous medium is proportional to the potential energy gradient within that fluid. The constant of proportionality is the hydraulic conductivity; the hydraulic conductivity is a property of both the porous medium and the fluid moving through the porous medium. The constant of proportionality in Darcy's Law, the hydraulic conductivity (K), must depend on both properties of the porous medium itself as well as the fluids percolating through it. For example, if a viscous fluid such as heavy oil is substituted for water, the Darcy velocity would be expected to be diminished even though no change was made in the nature of the porous medium itself. Similarly, substitution of a coarse-grained gravel for a fine-grained sand, would cause the fluid velocity to increase even if no change were made in the nature or composition of the fluid. Thus the single parameter K must depend on a number of other parameters, one or more of which characterize the porous medium, and one or more of which characterize the fluid.

It would be desirable to develop a modeling technique that takes into account non-Darcy factors in developing the model. These include compensation for the gases flowing in the fracture and not measurable by known techniques, compensation for height and perforation length of the fracture and the number of layers involved in the well being modeled, each layer having different properties.

The subject invention is directed to a simulation model that not only takes into account the known techniques for modeling but adds a compensation factor for the well-specific information. As an example, well logging data and pressure transient data which is collected can be used to predict performance in new fractures. However, this information does not include the unmeasured characteristics of the well, typically referred to as PVT data or the fluid properties by which the well can be characterized.

If a well is modeled without using this information, the well log data and pressure transient data will produce a performance prediction based on assumptions, rather than factual data. While useful, this result is not optimized.

The subject invention is directed to a modeling technique that permits optimization of the model by taking into account the impact of the PVT data on the model. This is accomplished by starting with a standard modeling technique and measuring it against actual performance for a known production zone of a well. The model is then corrected based on the actual performance data compared with the predicted performance data. A reiterative process is used to modify the model to comply with actual data by taking into account not only the well logging data and the pressure transient data, but also the PVT data. Once a match is achieved, the model produces an optimized performance prediction.

Specifically, the subject invention is directed to a model system for simulating the performance of a subterranean well, starting with a base model wherein input logging data, pressure transient data and PVT data is introduced into the base model. A numerical interpreter then calculates the predicted performance of the well. A match system compares actual performance data with calculated performance data based on the base model through a reiterative loop for modifying the base model to provide a match between the actual performance data and the predicted performance data to optimize the base model.

Where desirable, a data editing model may be utilized for editing the pressure transient data before it is input into the base model to eliminate noise and ambiguities. Various plotting devices may be included for plotting the data generated by the system.

The method for generating the optimized performance data in accordance with the subject invention incorporates the steps of introducing known pressure transient data, well logging data and PVT data for the well into a base model and producing a performance prediction from the base model. These results are compared with actual performance data and the model is modified to generate a performance prediction that matches the actual performance for producing an optimized model. The method is particularly useful because it accounts for and adjusts the performance prediction based on non-Darcy factors effecting the fluid parameters in the well.

Typically, the optimized model is generated by comparing predicted and actual performance data for a first, known zone and wherein the optimized model may then be utilized to predict performance data for an unknown zone. The model may then be repeatedly optimized as actual performance data for multiple zones is collected.

It is, therefore, an object and feature of the subject invention to provide a model for simulating well performance incorporating PVT data as well as known well log and pressure transient data.

It is another object and feature of the subject invention to provide a model for simulating well performance adapted for generating optimized performance prediction data through an iterative modeling process assuring a model that generates predicted data consistent with measured data as it becomes available.

It is a further object and feature of the subject invention to provide a model for simulating well performance which can be updated, on the fly, by taking into account changing PVT data depending on the fracture height and perforation length, the number and location of layers in the well, and the non-Darcy factors controlling fluid operation characteristics.

Other objects and features of the subject invention will be readily apparent from the accompanying drawings and detailed description of the preferred embodiment.

### BRIEF DESCRIPTION OF DRAWINGS

FIG. 1 is a basic block diagram of the invention.

FIG. 2 is an expanded block diagram of the invention incorporating all of the features of the system of FIG. 1.

### DETAILED DESCRIPTION

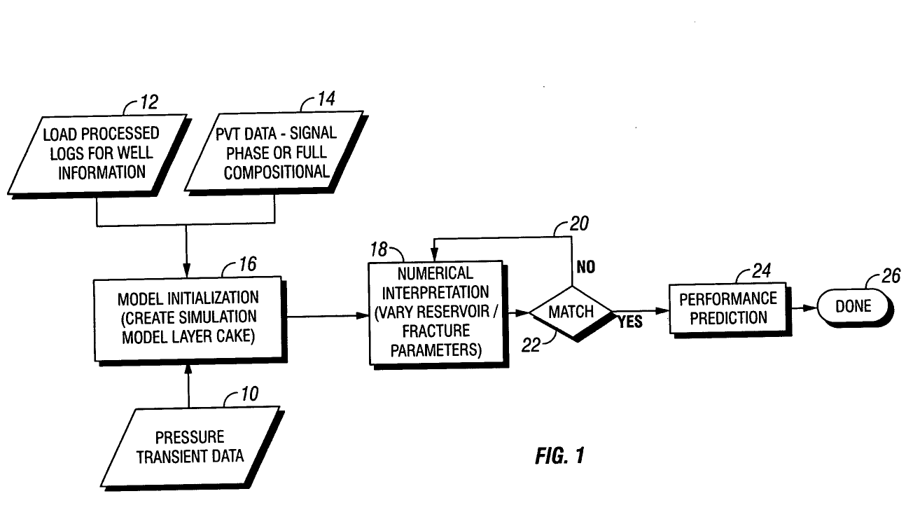

The basic components of the subject invention are shown in FIG. 1. As there shown, there are three input categories for the model simulator, pressure transient data 10, load processed logs for well information 12 and PVT data 14. This is combined at a model initiation stage 16, where the simulation model is created. This model is then input into a numerical interpretation module 18 where the reservoir and fracture parameters may be varied. In order to develop the optimized model, a reiterative loop 20 is utilized as shown at match block 22.

Specifically, the actual measured parameters are known for a specific layer of the well being modeled and these are input at the logging data input 12 and the pressure transient data 10. This produces a known performance. This known performance is then measured against predicted performance based on the initial model. The difference between the initial model and the actual performance is due to the PVT data which is generated and input at block 14. This provides useful information for correcting the historic model and optimizing the performance prediction at block 24. Basically, the numerical interpretation step at block 18 is repeated and the model is modified until there is correlation or a match between the predicted results and the actual performance results for a known layer or zone in the well. This takes into account the PVT data, whether in single phase or in full compositional phase and provides an optimized performance prediction at module 24, completing the modeling sequence as indicated at block 26.

As is known in the art, the processed log information at input block 12 includes the layering information, i.e., layer thickness, porosity, fluid saturation and net-to-gross ratio. The pressure transient data is the actual incasement pressure as measured by well test. The PVT data, which heretofore has largely ignored in modeling schemes, includes fluid properties existing at the well, i.e., properties by which reservoir fluid can be characterized. This can be either blackoil or compositional. Blackoil means that he properties are given in terms of oil, water or gas. This takes into account the non-Darcy fluid characteristics and provides the required input to modify and optimize historic models, thereby permitting the optimization of performance predictions in the instant invention.

The reservoir simulation model is a mathematical modeling system that simulates the behavior of the reservoir. The base simulator, shown at 16, will not produce actual performance data due to the lack of attention to the actual fracture properties. By introducing the PVT data, this is overcome. However, many of these properties cannot be measured by typical means. Therefore, by using a known model at step 16, and comparing it with actual performance data at step 18, the model can be modified and the PVT data can be verified. Once a match is achieved between predicted performance and actual performance, the model is optimized and a MATCH is indicated at loop gate 22. At this point actual and predicted performance match for a known layer of the well. The model can then be used to optimize the performance prediction for additional layers and fractures.

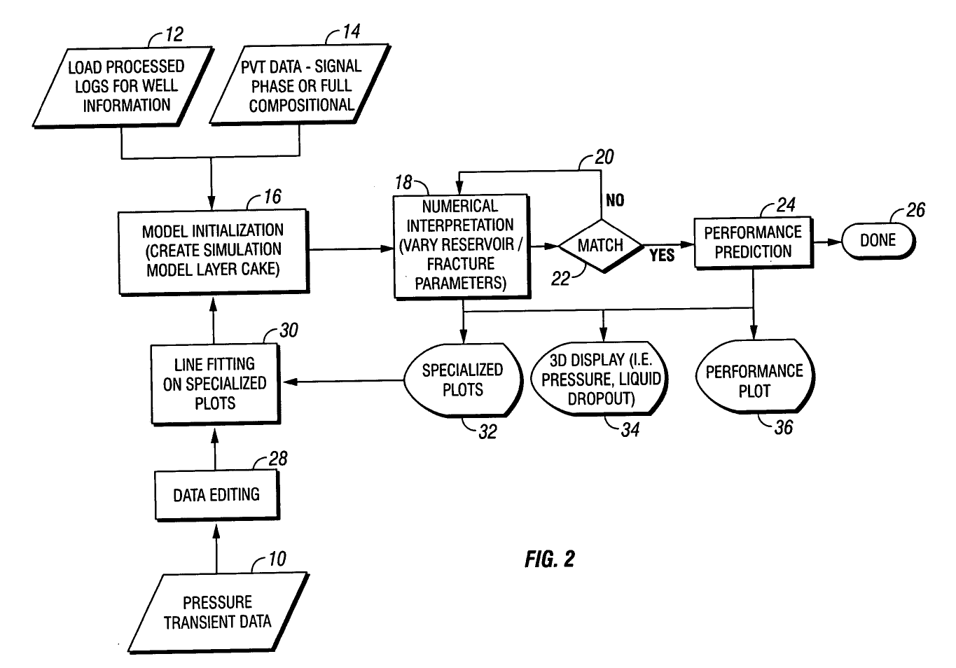

The embodiment of FIG. 2 is a comprehensive system incorporating features further optimizing the modeling system of the subject invention. As there shown, and as is well known in the arts, the pressure transient data is edited, or cleaned at step 28. This removes any noise or ambiguities in the pressure transient data. This edited data may then be plotted as indicated at module 30.

Specialized plots, as modified by the simulator 18 may be produced as indicated at 32, for providing preliminary estimates. 3D displays may be generated as indicated at 32. The optimized performance plots are generated at 36.

The subject invention provides a sophisticated optimizing simulator for producing optimized performance data taking into account historic pressure transient data and well logging data, and in addition, PVT data for modifying the base model. While certain features and embodiments of the invention have been described in detail herein, it should be understood that the invention includes all modifications and enhancements that are within the scope and spirit of the following claims.

What is claimed is:

1. A model system for simulating the performance of a subterranean well, comprising
a. a base model;
b. an input device for inputting well logging data into the base model;
c. an input device for inputting pressure transient data into the base model;
d. an input device for inputting PVT data into the base model;
d. a numerical interpreter for calculating predicted performance of the well;
e. a match system for comparing actual performance data with calculated performance data based on the base model;
f. a reiterative loop for modifying the base model to provide a match between the actual performance data and the predicted performance data to optimize the base model.

2. The model system of claim 1, further including a data editing module for editing the pressure transient data before it is input into the base model.

3. The model system of claim 1, further including a plotting device for plotting the data generated by the system.

4. The model system of claim 3, wherein the plotting device is adapted for plotting line fitting on specialized plots.

5. The model system of claim 3, wherein the plotting device is adapted for plotting specialized plots providing preliminary estimates of performance data based on the base model.

6. The model system of claim 3, wherein the plotting device is adapted for generating a 3D display of the well.

7. The model system of claim 3, wherein the plotting device is adapted for generating performance data plots based on the optimized model.

8. A method for generating optimized performance data in a subterranean well, comprising the steps of:
a. introducing known pressure transient data, well logging data and PVT data for the well into a base model;
b. producing a performance prediction from the base model;
c. comparing the performance prediction with actual performance;
d. modifying the model to generate a performance prediction that matches the actual performance for producing an optimized model.

9. The method of claim 8, wherein the PVT data includes non-Darcy factors effecting the fluid parameters in the well.

10. The method of claim 8, wherein the optimized model is generated by comparing predicted and actual performance data for a first, known zone and wherein the optimized model may then be utilized to predict performance data for an unknown zone.

11. The method of claim 10, wherein the model may be repeatedly optimized as actual performance data for multiple zones is collected.
